(19) United States
(12) Patent Application Publication
(10) Pub. No.: US 2007/0008487 A1
(43) Pub. Date: Jan. 11, 2007

(54) Bolt for spectacles

(76) Inventor: Jeffrey Wang Lee, Yung-Kang City (TW)

Correspondence Address: COOPER & DUNHAM, LLP, 1185 AVENUE OF THE AMERICAS, NEW YORK, NY, 10036, US

(21) Appl. No.: 11/175,613

(22) Filed: Jul. 6, 2005

(51) Int. Cl. G02C 5/00

(52) U.S. Cl. 351/140

(57) ABSTRACT

A bolt for spectacles has a head formed in a first end thereof and a threaded shank formed in a second end thereof, a nut threadedly mounted on the shank, and an arcuate lug formed in the shank whereby the bolt for the spectacles is inserted into and positions a lens and a rim thereby prevents a user from injury, thereby increasing the usage safety.

### BACKGROUND OF THE INVENTION

1. Field of the Invention

The present invention relates to a bolt for spectacles, and more particular to the bolt which can mate a rim with a lens without causing unsafe edges to be formed on the bolt.

2. Description of Related Art

With reference to FIG. 5, a pair of spectacles comprises a rim (20) and two lenses (10). Multiple holes (21) are respectively defined in the rim (20) and multiple orifices (11) which correspond to the holes (21) are respectively defined in a periphery of each lens (10). It is to be appreciated that although multiple holes, orifices etc are involved, for the sake of clarity a single bolt is referred to hereinafter. A conventional bolt (40) with a head (401) and a threaded shank (402) is sequentially inserted into a sleeve (41), the orifice (11) and the hole (21), and a nut (42) is threadedly mounted around the threaded shank (402) of the bolt (40) so that the lens (20) is securely positioned on the rim (10). A distal tip of the threaded shank (402) is deformed by use of a punch etc to create a lug (403) to prevent the nut (42) being separated from the bolt (40).

However, the lug (403) has a rough edge such that a user may be easily hurt, especially in the very sensitive area of the eyes.

Therefore, the invention provides a bolt for spectacles to mitigate or obviate the aforementioned problems.

### SUMMARY OF THE INVENTION

The main objective of the present invention is to provide a bolt for spectacles to securely mate a rim and two lenses of the spectacles and to increase the usage safety of the spectacles.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a bolt for spectacles being mounted on a rim and a lens;

FIG. 2 is an exploded view of the bolt for the spectacles with the rim and the lens, in partial section;

FIG. 3 is a view of the bolt for the spectacles being mounted on the rim and the lens, in partial section;

FIG. 4 is a side plan view in partial cross section of the bolt for the spectacles with an arcuate lug being mounted on the rim and the lens; and

FIG. 5 is a view of a conventional bolt for spectacles being mounted on the rim and the lens, in partial section.

### DETAILED DESCRIPTION OF THE PREFERRED EMBODIMENT

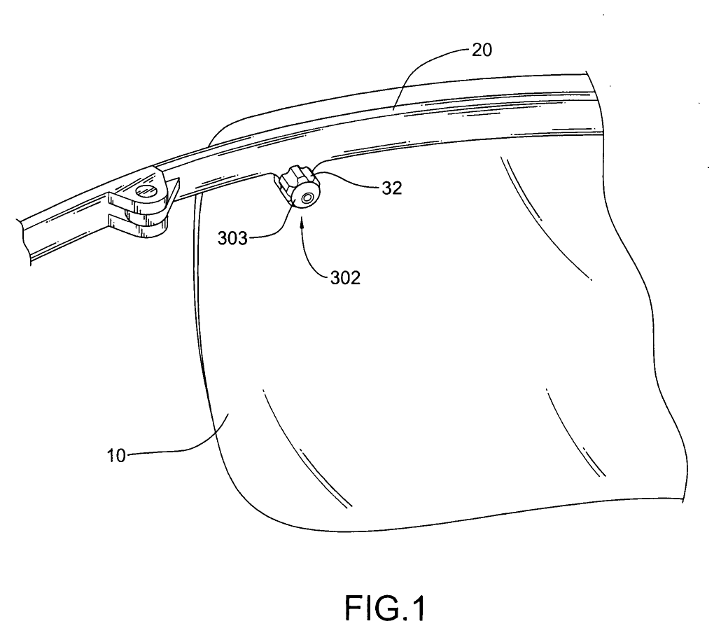

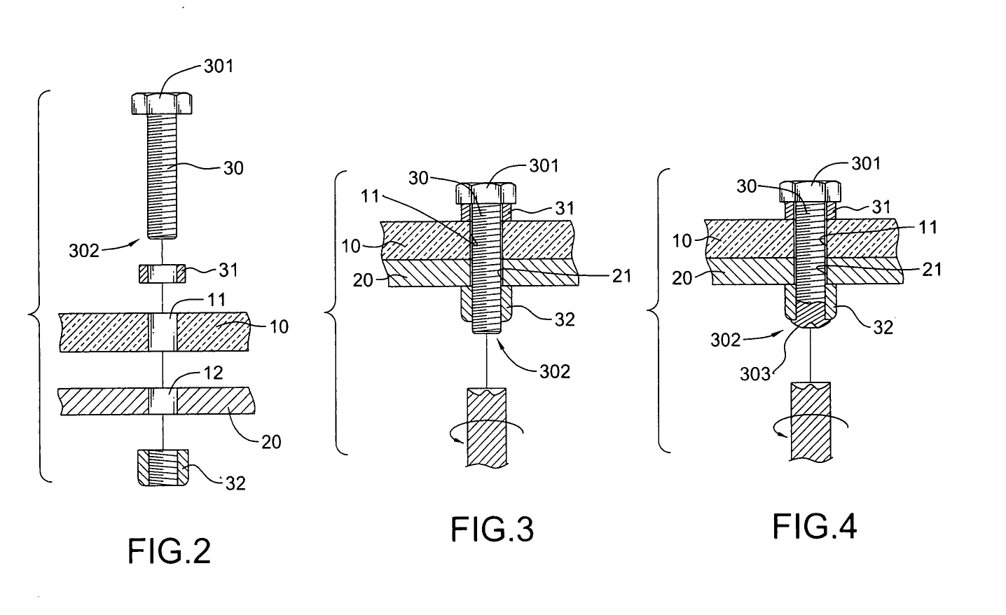

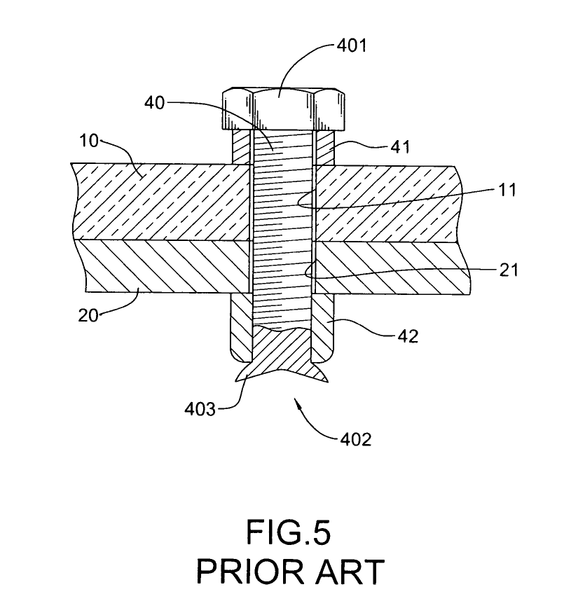

With reference to FIGS. 1-4, a bolt (30) for spectacles comprises a head (301) formed at a first end thereof, and a threaded shank (302) formed at a second end thereof. At least one hole (11) is defined in a periphery of a lens (10) and at least one orifice (21) corresponding to the hole (11) is defined in a rim (20). The bolt (30) for the spectacles is inserted into the hole (11) and the orifice (21) in sequence and a nut (32) is threadedly mounted around the threaded shank (302) so that the lens (10) can be securely attached to the rim (20).

When the lens (10) is securely mated with the rim (20), an arcuate lug (303) is formed on a distal tip of the shank (302) by a punching process with a specific mold or by a cutting process with a rotating mold to prevent a user being hurt thereby increasing the usage safety. A sleeve (31) is mounted around the bolt (30) and between the head (301) and the hole (11) so that the head (301) is indirectly connected to the lens (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bolt for spectacles comprising:
a head (301) formed in a first end thereof and a threaded shank (302) formed in a second end thereof, a nut (32) threadedly mounted on the threaded shank (302), and an arcuate lug (303) formed in the threaded shank (302) by a specific mold whereby the bolt for the spectacles is inserted into and positions a lens (10) and a rim (20).

2. The bolt for spectacles as claimed in claim 1, wherein a sleeve (41) is mounted around the bolt.
